(19) United States
(12) Patent Application Publication
(10) Pub. No.: US 2026/0027752 A1
(43) Pub. Date: Jan. 29, 2026

(54) REPLICA MOLD MANUFACTURING METHOD AND ARTICLE MANUFACTURING METHOD

(71) Applicant: CANON KABUSHIKI KAISHA, Tokyo (JP)

(72) Inventors: KEN KATSUTA, Saitama (JP); TOSHIKI ITO, Kanagawa (JP)

(21) Appl. No.: 19/258,265

(22) Filed: Jul. 2, 2025

(30) Foreign Application Priority Data
Jul. 23, 2024 (JP) 2024-117964

(51) Int. Cl. B29C 33/38; B29C 33/42; B29L 31/00

(52) U.S. Cl. CPC B29C 33/3842; B29C 33/424; B29K 2995/0097; B29L 2031/757

(57) ABSTRACT

A method of manufacturing a replica mold includes filling a curable composition into a space between a replica blank and a pattern region of a master mold; curing the curable composition to form a replica pattern portion with a pattern of the pattern region transferred thereto; and separating the replica pattern portion and the master mold from each other. The master mold includes a pattern peripheral region surrounding the pattern region, and there is a step between the pattern region and the pattern peripheral region, and an area of the replica pattern portion at a bonding interface between the replica blank and the replica pattern portion is larger than an area of the pattern region.

### BACKGROUND

### Field of the Technology

The present disclosure relates to a replica mold manufacturing method and an article manufacturing method.

### Description of the Related Art

One pattern forming method for manufacturing articles such as a semiconductor device and MEMS is an imprint process. The imprint process is a process in which a curable composition is arranged on a substrate, the curable composition is brought into contact with the pattern region of a mold, the curable composition is cured, and the mold is separated from the cured product of the curable composition, thereby forming a pattern on the substrate.

By repeatedly executing the imprint process, the mold can be deteriorated through the contact between the mold and the curable composition. Since the mold is very expensive, its deterioration can cause an increase in article manufacturing cost. To prevent this, a method has been proposed in which a master mold is used to replicate multiple replica molds at a low cost, and the imprint process is executed using the replica mold. Japanese Patent No. 5395756 describes a method for manufacturing such an imprint template. In the manufacturing method described in Japanese Patent No. 5395756, a resin is first applied on the concave-convex portion provided in the main surface of the base substrate, and the resin is cured in a state in which an original formed with a master pattern is in contact with the resin, and then the original is released from the resin. With this, a pattern transfer portion having a concave-convex pattern, in which the concave-convex pattern to be molded is inverted, can be provided on the main surface of the base substrate.

Although the replica mold can be manufactured at a much lower cost than the master mold, if the replica mold is easily damaged, this results in an increase in article manufacturing cost by the imprint process. One factor that causes damage to the replica mold is a foreign substance sandwiched between the substrate and the replica mold. To decrease the damage to the replica mold due to a foreign substance, it is considered to be advantageous to increase the thickness of the replica pattern portion of the replica mold which is formed of the cured product of the curable composition. However, in this case, when filling an uncured curable composition into the space between the master mold and a replica blank for manufacturing the replica mold, the controllability of the outer peripheral portion of a liquid film formed of the uncured curable composition can be poor. This makes it difficult to manufacture the replica mold that meets specifications.

### SUMMARY

The present disclosure provides a technique advantageous in manufacturing a replica mold.

The present disclosure includes a method of manufacturing a replica mold, the method comprising: filling a curable composition into a space between a replica blank and a pattern region of a master mold; curing the curable composition to form a replica pattern portion with a pattern of the pattern region transferred thereto; and separating the replica pattern portion and the master mold from each other, wherein the master mold includes a pattern peripheral region surrounding the pattern region, and there is a step between the pattern region and the pattern peripheral region, and an area of the replica pattern portion at a bonding interface between the replica blank and the replica pattern portion is larger than an area of the pattern region.

Features of the present disclosure will become apparent from the following description of embodiments with reference to the attached drawings. The following description of embodiments are described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a view schematically showing the arrangement of a replica mold manufacturing apparatus according to the first embodiment;

FIGS. 2A to 2D are schematic views showing a replica mold manufacturing method according to the first embodiment;

FIGS. 3A to 3C are views each schematically showing the sectional structure near the end portion of the pattern region of a master mold and the end portion of the replica region of a replica blank;

FIGS. 4A to 4D are schematic views showing a replica mold manufacturing method according to the second embodiment; and

FIGS. 5A to 5C are views each schematically showing the sectional structure near the end portion of the pattern region of a master mold and the end portion of the replica region of a replica blank.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

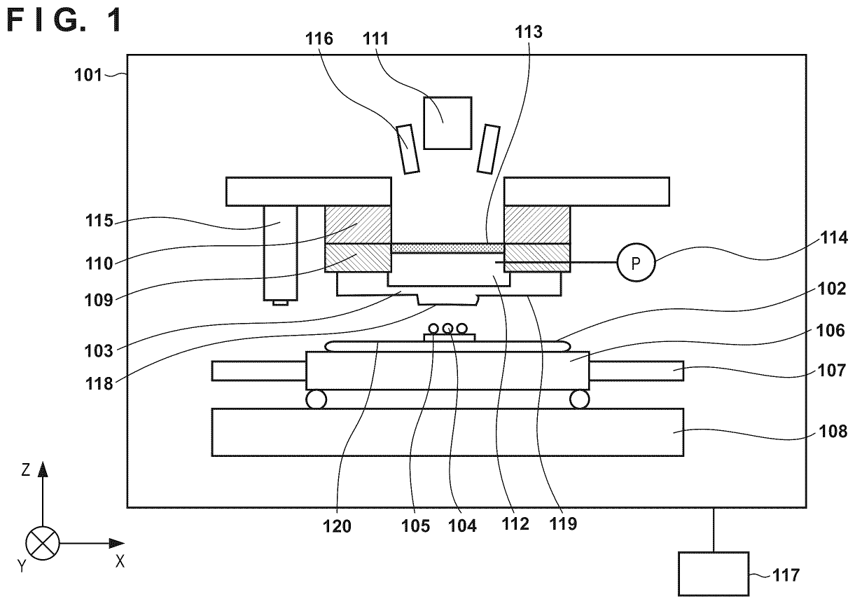

FIG. 1 is a view schematically showing the arrangement of a replica mold manufacturing apparatus 101 according to the first embodiment. The replica mold manufacturing apparatus 101 manufactures a replica mold by using a master mold 102 and forming a replica pattern portion, which is a replica of the master mold 102, on a replica blank 103. The master mold 102 can include a pattern region 105 having a pattern, and a pattern peripheral region 120 surrounding the pattern region 105. There can be a step between the pattern region 105 and the pattern peripheral region 120. In the first embodiment, the master mold 102 has a mesa, and the pattern region 105 is arranged in the mesa. In other words, in the first embodiment, the master mold 102 has a shape in which the pattern region 105 protrudes from the surface to which the pattern peripheral region 120 belongs, so that a step is formed. Note that in the second embodiment, an example will be described in which a master mold 102 has a concave portion, and a pattern region 105 is arranged in the concave portion.

The replica mold manufacturing apparatus 101 brings an uncured curable composition 104 arranged on the master mold 102 into contact with the replica blank 103, thereby filling the curable composition 104 into the space between the master mold 102 and the replica blank 103. The uncured curable composition 104 can be arranged on the master mold 102 in a state of a plurality of droplets. After that, the replica mold manufacturing apparatus 101 cures the curable composition 104. With this, a replica pattern portion to which the pattern in the pattern region 105 of the master mold 102 has been transferred is formed. Here, the replica pattern portion is formed in a state in which it is bonded to a replica region 118 of the replica blank 103. After that, the replica mold manufacturing apparatus 101 separates the replica pattern portion from the pattern region 105 of the master mold 102. Thus, a replica mold formed from the replica blank 103 and the replica pattern portion connected thereto is formed.

The replica blank 103 may have, for example, a mesa. In this case, the replica region 118 is arranged on the top surface of the mesa, and the replica pattern portion is formed on the mesa of the replica blank 103. The area of the top surface of the mesa of the replica blank 103 is larger than the area of the pattern region 105 of the master mold 102. The replica blank 103 can include a replica peripheral region 119 surrounding the replica region 118. There may be a step between the replica region 118 and the replica peripheral region 119, as schematically shown in FIG. 1. In other words, the replica blank 103 can have a shape in which the replica region 118 protrudes from the surface to which the replica peripheral region 119 belongs, so that a step is formed. However, this is merely an example, and there may be no step between the replica region 118 and the replica peripheral region 119.

In the arrangement example shown in FIG. 1, the master mold 102 is arranged below the replica blank 103, but the master mold 102 may be arranged above the replica blank 103. In that case, the replica mold manufacturing apparatus 101 arranges the uncured curable composition 104 on the replica blank 103, and then brings the master mold 102 into contact with the uncured curable composition 104 arranged on the replica blank 103. With this, the curable composition 104 is filled into the space between the master mold 102 and the replica blank 103.

The pattern region 105 and the replica region 118 may have various shapes such as a rectangular shape and a circular shape. In the first embodiment, a description will be given assuming that each of the pattern region 105 and the replica region 118 has a rectangular shape in the X-Y plane. The master mold 102 may include a plurality of pattern regions 105 arranged spaced apart from each other.

As the curable composition 104, a material to be cured by receiving curing energy is used. An example of the curing energy that is used is electromagnetic waves, heat, or the like. As the electromagnetic waves, for example, infrared light, visible light, ultraviolet light, and the like selected from the wavelength range of 10 nm (inclusive) to 1 mm (inclusive) is used. Thus, the curable composition 104 is a composition cured by light irradiation or heating. The photo-curable composition cured by light irradiation contains at least a polymerizable compound and a photopolymerization initiator, and may contain a nonpolymerizable compound or a solvent, as needed. The nonpolymerizable compound is at least one type of material selected from the group consisting of a sensitizer, a hydrogen donor, an internal mold release agent, a surfactant, an antioxidant, a polymer component, and the like. The viscosity (the viscosity at 25° C.) of the curable composition is, for example, 1 mPa·s (inclusive) to 100 mPa·s (inclusive).

The master mold 102 can be formed from, for example, a silicon wafer, a compound semiconductor wafer, or silica glass. For the replica blank 103, for example, glass, a ceramic, a metal, a semiconductor, a resin, or the like is used. A member made of a material different from that of the substrate may be provided on the surface of the substrate, as needed.

In the specification and the accompanying drawings, directions will be indicated on an XYZ coordinate system in which directions parallel to the surface of the master mold 102 are defined as the X-Y plane. Directions parallel to the X-axis, the Y-axis, and the Z-axis of the XYZ coordinate system are the X direction, the Y direction, and the Z direction, respectively. A rotation about the X-axis, a rotation about the Y-axis, and a rotation about the Z-axis are θX, θY, and θZ, respectively. Control or driving concerning the X-axis, the Y-axis, and the Z-axis means control or driving concerning a direction parallel to the X-axis, a direction parallel to the Y-axis, and a direction parallel to the Z-axis, respectively. In addition, control or driving concerning the θX-axis, the θY-axis, and the θZ-axis means control or driving concerning a rotation about an axis parallel to the X-axis, a rotation about an axis parallel to the Y-axis, and a rotation about an axis parallel to the Z-axis, respectively. In addition, a position is information that is specified based on coordinates on the X-, Y-, and Z-axes, and a posture is information that is specified by values on the θX-, θY-, and θZ-axes. Positioning means controlling the position and/or posture.

The replica mold manufacturing apparatus 101 can include a first holder 106 that holds the master mold 102, a first driving mechanism 107 that moves the master mold 102 by driving the first holder 106, and a support base 108 that supports the first driving mechanism 107. The replica mold manufacturing apparatus 101 can also include a second holder 109 that holds the replica blank 103, and a second driving mechanism 110 that moves the replica blank 103 by driving the second holder 109.

The first driving mechanism 107 and the second driving mechanism 110 form a relative driving mechanism that drives at least one of the master mold 102 and the replica blank 103 so as to adjust the relative position between the master mold 102 and the replica blank 103. Adjustment of the relative position between the master mold 102 and the replica blank 103 by the relative driving mechanism can include driving for bringing the curable composition 104 on the master mold 102 into contact with the replica blank 103. Adjustment of the relative position between the master mold 102 and the replica blank 103 by the relative driving mechanism can also include driving for separating the replica pattern portion formed of the cured product of the curable composition 104 from the master mold 102. Adjustment of the relative position between the master mold 102 and the replica blank 103 by the relative driving mechanism can also include alignment between the master mold 102 and the replica blank 103. The first driving mechanism 107 can be configured to drive the master mold 102 with respect to a plurality of axes (for example, three axes including the X-axis, Y-axis, and θZ-axis, and preferably six axes including the X-axis, Y-axis, Z-axis, θX-axis, θY-axis, and θZ-axis). The second driving mechanism 110 can be configured to drive the replica blank 103 with respect to a plurality of axes (for example, three axes including the Z-axis, θX-axis, and θY-axis, and preferably six axes including the X-axis, Y-axis, Z-axis, θX-axis, θY-axis, and θZ-axis).

The replica mold manufacturing apparatus 101 can include a curing unit 111 for curing the curable composition 104 filled into the space between the master mold 102 and the replica blank 103. The curing unit 111 can cure the curable composition 104 between the master mold 102 and the replica blank 103 by, for example, applying curing energy to the curable composition 104 via the replica blank 103.

The replica mold manufacturing apparatus 101 can include a transmissive member 113 for forming a pressure control space 112 on the back surface side (the opposite side of a surface facing the master mold 102) of the replica blank 103. The transmissive member 113 is formed of a material that transmits curing energy from the curing unit 111, and allows application of the curing energy to the curable composition 104 between the master mold 102 and the replica blank 103.

The replica mold manufacturing apparatus 101 can include a pressure control unit 114 that controls deformation of the replica blank 103 in the Z-axis direction by controlling the pressure in the pressure control space 112. For example, when the pressure control unit 114 makes the pressure in the pressure control space 112 higher than the atmospheric pressure, the replica blank 103 is deformed into a convex shape toward the master mold 102.

The replica mold manufacturing apparatus 101 can include an application unit 115 used to arrange, supply, or distribute the curable composition 104 on the master mold 102. However, the master mold 102 on which the curable composition 104 is arranged by another apparatus may be supplied or loaded to the replica mold manufacturing apparatus 101. In this case, the replica mold manufacturing apparatus 101 need not include the application unit 115.

The replica mold manufacturing apparatus 101 can include a measuring unit 116 for measuring the positional shift (alignment error) between the master mold 102 and the replica blank 103. The replica mold manufacturing apparatus 101 can include a controller 117 that can be formed from a computer installed with a program for controlling operations of a plurality of components constituting the replica mold manufacturing apparatus 101. The controller 117 may be formed by a PLD (the abbreviation of a Programmable Logic Device) such as an FPGA (the abbreviation of a Field Programmable Gate Array), or an ASIC (the abbreviation of an Application Specific Integrated Circuit).

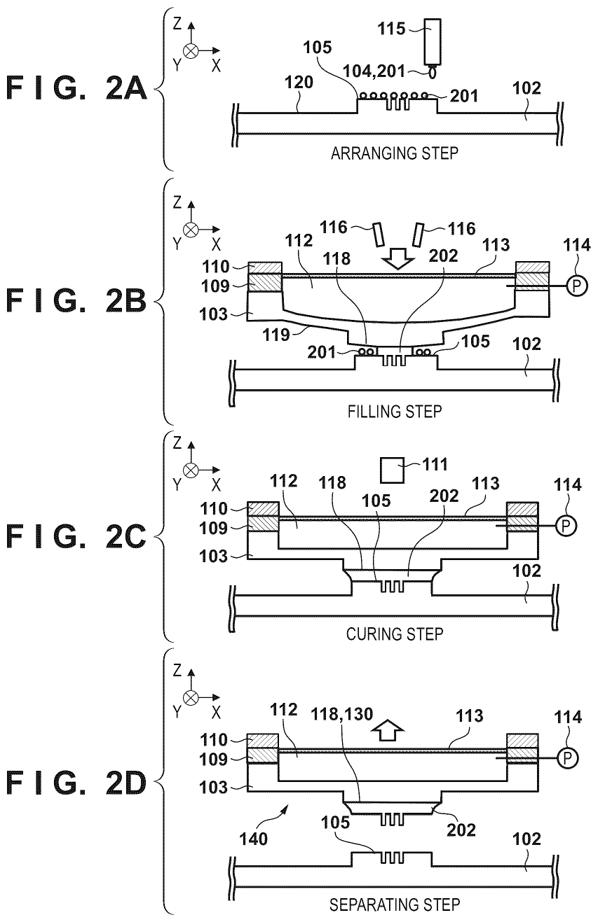

FIGS. 2A to 2D are schematic views showing the replica mold manufacturing method according to the first embodiment performed by the replica mold manufacturing apparatus 101. The replica mold manufacturing method can include, for example, an arranging step, a filling step, a curing step, and a separating step. The arranging step, the filling step, the curing step, and the separating step can be controlled by the controller 117. The coordinate system in FIGS. 2A to 2D follows the coordinate system shown in FIG. 1. Each of FIGS. 2A to 2D is a schematic view showing an X-Z section passing through the center of the pattern region 105 and the center of the replica region 118.

FIG. 2A schematically shows the arranging step. In the arranging step, the application unit 115 can apply or arrange the curable composition 104 as a plurality of droplets 201 on the pattern region 105 of the master mold 102. Note that the arranging step may be executed by an apparatus outside the replica mold manufacturing apparatus 101, as described above. The application unit 115 is controlled based on control information stored in advance in the controller 117, and can arrange the droplets 201 of the curable composition 104 on the pattern region 105.

Each droplet 201 arranged on the pattern region 105 spreads so that its diameter increases, but at this point of time, the droplet 201 can maintain the droplet shape without contacting the other droplets 201. In the filling step to be described below, the droplets 201 are squashed between the pattern region 105 of the master mold 102 and the replica region 118 of the replica blank 103 and connected to each other, thereby forming a liquid film.

The above-described control information can include a list of information concerning the volume of each droplet 201, and information concerning the arrangement position (X coordinate and Y coordinate) with respect to the pattern region 105 (master mold 102). The number and arrangement positions of the plurality of droplets 201 can be decided mainly in accordance with the target thickness of the liquid film of the curable composition 104 to be formed between the pattern region 105 and the replica region 118.

The droplet driving method in the application unit 115 is not limited to a specific driving method. For example, an electrically-driven piezoelectric actuator can be employed. When the piezoelectric actuator is employed, it is possible to control the volume of the droplet 201 by controlling the voltage value applied to the piezoelectric actuator. The arrangement position of the droplet 201 can be controlled by adjusting the relative position between the master mold 102 and the application unit 115. For example, by controlling the discharge timing of the droplet 201 by the application unit 115 in accordance with the position of the master mold 102 driven by the first driving mechanism 107, the droplet 201 can be arranged at a target position on the master mold 102.

FIG. 2B schematically shows the filling step. In the filling step, the curable composition is filled into the space between the replica region 118 of the replica blank 103 and the pattern region 105 of the master mold 102. The filling step includes a contact step of bringing the droplets 201 of the curable composition arranged on the pattern region 105 of the master mold 102 into contact with the replica region 118 of the replica blank 103. When the droplets 201 of the curable composition arranged on the pattern region 105 are brought into contact with the replica region 118, the curable composition is started to be filled into the space between the pattern region 105 and the replica region 118. In the filling step, the curable composition spreads along the top surface (replica region 118) of the mesa of the replica blank 103, and can reach the end portion of the top surface.

The spacing between the pattern region 105 and the replica region 118 is expressed by a value obtained by dividing, by the area of the pattern region 105, the volume calculated by subtracting the volumes of the concave portions of the pattern region 105 from the total volume of the curable composition calculated from the number of droplets given by the list concerning the droplets included in the control information. Note that the concave portion of the pattern region 105 means the concave portion forming the pattern. In the contact step, the droplets 201 of the curable composition are preferably brought into contact with the replica region 118 in a state in which the central portion of the replica blank 103 is bent downward in a convex shape by increasing the pressure in the pressure control space 112 by the pressure control unit 114. With this, gas entrapment in the space between the pattern region 105 and the replica region 118 can be reduced. The relative position between the replica blank 103 and the master mold 102 in the X direction and the Y direction can be adjusted before the droplets 201 of the curable composition are brought into contact with the replica region 118. The relative position between the replica blank 103 and the master mold 102 in the X direction and the Y direction may further be adjusted after the droplets 201 of the curable composition are brought into contact with the replica region 118. When bringing the droplets 201 of the curable composition into contact with the replica region 118, the convex shape of the replica blank 103 is preferably reduced by controlling the pressure in the pressure control space 112 by the pressure control unit 114. When completing the filling, the pressure in the pressure control space 112 and the posture (inclination) of the pressure control space 112 can be controlled such that the lower surface of a replica pattern portion 202 (the top surface of the mesa) becomes flat and parallel to the enveloping surface of the pattern region 105. The thickness of the replica pattern portion 202 may fall within a range of 0.1 μm (inclusive) to 1,000 μm (inclusive), preferably falls within a range of 0.5 μm (inclusive) to 100 μm (inclusive), and more preferably falls within a range of 0.7 μm (inclusive) to 10 μm (inclusive).

In the filling step, if the liquid film of the curable composition overflows outside from the space between the pattern region 105 and the replica region 118, the shape of the formed replica pattern portion 202 deviates from the target shape. In addition, in the filling step, if the liquid film of the curable composition overflows from the space between the pattern region 105 and the replica region 118 along the side surface of the pattern region 105 of the master mold 102, the replica pattern portion 202 including a projection protruding downward in FIG. 2 can be formed. This means that, when using the manufactured replica mold in the imprint process, a substrate as a pattern formation target can be damaged, or a defect can be generated in the pattern formed by the imprint process. In addition, if the liquid film of the curable composition overflows outside from the space between the pattern region 105 and the replica region 118, the volume of the curable composition in the space between the pattern region 105 and the replica region 118 decreases, and a defect can be generated in the formed replica pattern portion 202.

FIG. 2C schematically shows the curing step. In the curing step, the replica pattern portion 202 with the pattern of the pattern region 105 transferred thereto is formed by curing the curable composition. When the curing unit 111 applies curing energy to the liquid film of the curable composition between the pattern region 105 and the replica region 118, the curable composition is cured and the replica pattern portion 202 is formed. Curing of the curable composition can be accompanied by a shrinkage of the volume of the curable composition. This shrinkage makes it easy to separate the pattern region 105 from the formed replica pattern portion 202.

FIG. 2D schematically shows the separating step. In the separating step, the replica pattern portion 202 and the master mold 102 are separated from each other. In the separating step, for example, the second driving mechanism 110 can drive the replica blank 103 in a direction (+Z direction) away from the master mold 102. In the separating step, the controller 117 can separate the replica pattern portion 202 and the master mold 102 from each other by controlling the second driving mechanism 110 in accordance a driving profile set in advance. Here, in a state in which the replica blank 103 and the replica pattern portion 202 are connected to each other, the replica pattern portion 202 and the master mold 102 are separated from each other, and a replica mold 140 formed from the replica pattern portion 202 and the replica blank 103 is obtained. In the first embodiment, the area of the replica pattern portion 202 at a bonding interface 130 between the replica blank 103 and the replica pattern portion 202 is larger than the area of the pattern region 105. In addition, in an orthogonal projection to the bonding interface 130, the pattern region 105 fits in the region of the replica pattern portion 202 at the bonding interface 130. The bonding interface 130 between the replica blank 103 and the replica pattern portion 202 is the whole or a part of the replica region 118 of the replica blank 103.

The replica mold 140 manufactured by the manufacturing method described above is used in an imprint process for manufacturing an article. By repeating the imprint process using the replica mold 140, the replica pattern portion 202 can be deteriorated (including being damaged). If the replica pattern portion 202 is deteriorated, the new replica pattern portion 202 is preferably formed on the replica region 118 after the replica pattern portion 202 is peeled off from the replica mold 140 (replica blank 103). To peel off the replica pattern portion 202 from the replica mold 140 (replica blank 103), for example, the replica pattern portion 202 may be dissolved using a peeling solution. As the peeling solution, for example, a solution such as a mixture of H₂SO₄ (sulfuric acid) and H₂O₂ (hydrogen peroxide) can be used. Alternatively, the replica pattern portion 202 may be physically peeled off from the replica mold 140 (replica blank 103).

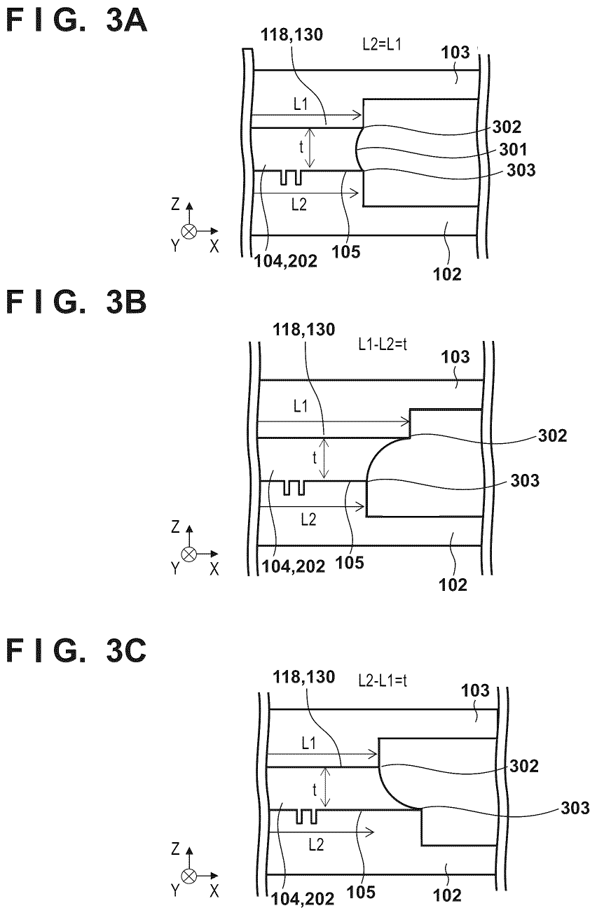

Each of FIGS. 3A to 3C schematically shows the sectional structure near the end portion of the pattern region 105 and the end portion of the replica region 118. With reference to FIGS. 3A to 3C, a preferable relationship between the area of the replica pattern portion 202 at the bonding interface 130 between the replica blank 103 and the replica pattern portion 202 and the area of the pattern region 105 of the master mold 102 will be described. Each of FIGS. 3A to 3C is a schematic view showing an X-Z section passing through the center of the pattern region 105 and the center of the replica region 118.

Let L1 be ½ the dimension of the bonding interface 130 in a direction (for example, the X direction) parallel to the bonding interface 130 between the replica blank 103 and the replica pattern portion 202, L2 be ½ the dimension of the pattern region 105 in this direction, and t be the thickness of the replica pattern portion 202. L1 may be understood as the distance from the center of the bonding interface 130 to the outer edge of the bonding interface 130. L2 may be understood as the distance from the center of the pattern region 105 to the outer edge of the pattern region 105.

FIG. 3A schematically shows a case where the area of the replica region 118 (or the bonding interface 130) and the area of the pattern region 105 are equal to each other, in other words, a case where L1 and L2 are equal to each other. The uncured curable composition 104 can form a meniscus (concave shape) 301 at the outer edge of the curable composition 104 during the final stage of the process of spreading in the space between the replica region 118 and the pattern region 105 (filling step). An outer edge 302 of the curable composition 104 at the contact interface between the replica region 118 (the top surface of the mesa of the replica blank 103) and the curable composition 104 extends along the replica region 118 (the top surface of the mesa) and can reach the end portion of the replica region 118. An outer edge 303 of the curable composition 104 at the contact interface between the pattern region 105 (the top surface of the mesa of the master mold 102) and the curable composition 104 extends along the pattern region 105 and can reach the end portion of the pattern region 105.

When the outer edges 302 and 303 of the curable composition 104 reach the end portion of the replica region 118 and the end portion of the pattern region 105, respectively, the spreading of the outer edges 302 and 303 of the curable composition 104 can temporarily stop. In this state, the external force applied to the curable composition 104 is expended in deformation of the meniscus 301. When the surface tension of the meniscus 301 and the external force are balanced, the spreading of the curable composition 104 completely stops. On the other hand, if the external force is greater than the surface tension of the meniscus 301, the curable composition 104 further spreads and overflows from the space between the pattern region 105 and the replica region 118. This means that the controllability of the outer peripheral portion of the liquid film formed of the curable composition 104 is poor. Here, the external force is, for example, a force applied to the curable composition 104 by the second driving mechanism 110 (or the relative driving mechanism). If the control error of the external force is absorbed (canceled) by the deformation of the meniscus 301, overflow of the curable composition 104 from the space between the pattern region 105 and the replica region 118 does not occur. On the other hand, if the control error of the external force cannot be absorbed (canceled) by the deformation of the meniscus 301, overflow of the curable composition 104 from the space between the pattern region 105 and the replica region 118 occurs.

FIG. 3B schematically shows an example of a case where the area of the replica region 118 (or the bonding interface 130) is larger than the area of the pattern region 105, in which L1−L2=t is satisfied. In this case, even if the control error of the external force acts in the direction of spreading the curable composition 104, it is absorbed by the outer edge 302 of the curable composition 104 at the contact interface between the replica region 118 and the curable composition 104 spreading along the replica region 118. This prevents overflow of the curable composition 104 along the side surface of the pattern region 105 of the master mold 102, and accordingly prevents formation of a projection of the replica pattern portion 202. This means that the controllability of the outer peripheral portion of the liquid film formed of the curable composition 104 is good. However, if the margin (L1−L2) is excessively large, it can cause a thickness defect of the formed replica pattern portion 202. If the control error of the external force acts in the direction of not spreading the curable composition 104, the outer edge 302 of the curable composition 104 at the contact interface between the replica region 118 and the curable composition 104 is located inward from the target position, so the problem of overflow does not occur.

FIG. 3C schematically shows an example of a case where the area of the pattern region 105 is larger than the area of the replica region 118 (or the bonding interface 130), in which L2−L1=t is satisfied. In this case, even if the control error of the external force acts in the direction of spreading the curable composition 104, it is absorbed by the outer edge 303 of the curable composition 104 at the contact interface between the pattern region 105 and the curable composition 104 spreading along the pattern region 105. This prevents overflow of the curable composition 104 along the side surface of the pattern region 105 of the master mold 102, and accordingly prevents formation of a projection of the replica pattern portion 202. However, if the area of the pattern region 105 is larger than the area of the replica region 118 (or the bonding interface 130), the area of the manufactured replica mold 140 that comes into contact with a curable composition in an imprint process becomes larger than the regular area. This means that the controllability of the outer peripheral portion of the liquid film formed of the curable composition 104 is poor. Hence, for example, other problems such as collision with an adjacent shot region can occur.

According to the study of the present inventors, the area of the replica pattern portion 202 at the bonding interface 130 between the replica blank 103 and the replica pattern portion 202 is preferably larger than the area of the pattern region 105 of the master mold 102. In another viewpoint, in order to prevent overflow of the curable composition to the side surface of the pattern region 105, the lower limit of (L1−L2) can be set to any one of 0.1t, 0.2t, 0.3t, 0.4t, 0.5t, 0.6t, 0.7t, 0.8t, and 0.9t. In order to prevent a thickness defect of the formed replica pattern portion 202, the upper limit of (L1−L2) can be set to any one of 2t, 1.9t, 1.8t, 1.7t, 1.6t, 1.5t, 1.4t, 1.3t, 1.2t, and 1.1t. In still another viewpoint, it is preferable that 0.1t≤L1−L2≤2t is satisfied, more preferably that 0.5t≤L1−L2≤1.5t is satisfied, and further preferably that 0.7t≤L1−L2≤1.3t is satisfied.

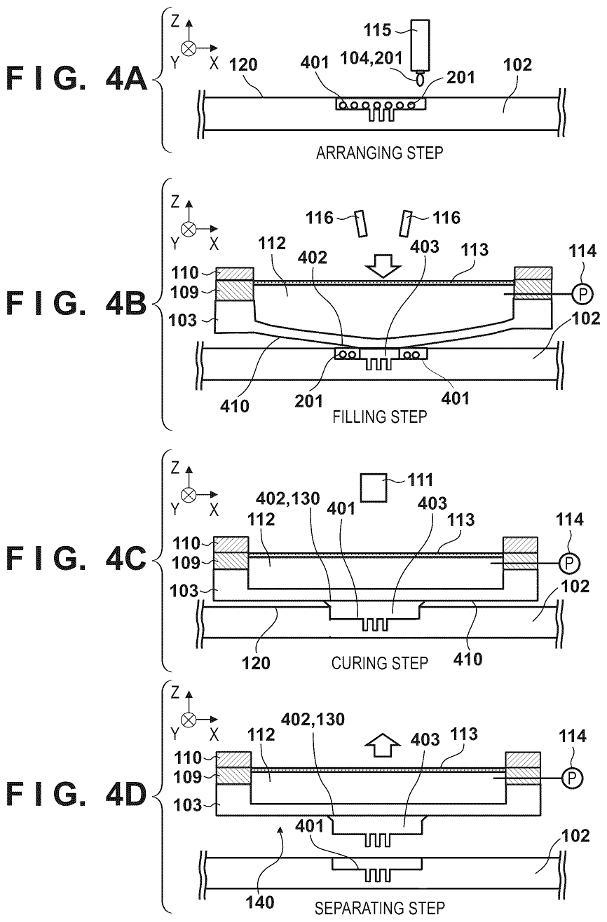

A replica mold manufacturing method according to the second embodiment performed by a replica mold manufacturing apparatus 101 will be described below. Matters not mentioned as the manufacturing method according to the second embodiment can follow the manufacturing method according to the first embodiment. FIGS. 4A to 4D are schematic views showing the replica mold manufacturing method according to the second embodiment performed by the replica mold manufacturing apparatus 101. The replica mold manufacturing method can include, for example, an arranging step, a filling step, a curing step, and a separating step. The arranging step, the filling step, the curing step, and the separating step can be controlled by a controller 117. The coordinate system in FIGS. 4A to 4D follows the coordinate system shown in FIG. 1. Each of FIGS. 4A to 4D is a schematic view showing an X-Z section passing through the center of a pattern region 401 and the center of a replica region 402.

In the second embodiment, a master mold 102 can include the pattern region 401 having a pattern, and a pattern peripheral region 120 surrounding the pattern region 401. There can be a step between the pattern region 401 and the pattern peripheral region 120. In the second embodiment, the master mold 102 has a concave portion, and the pattern region 401 is arranged in the concave portion. In other words, in the second embodiment, the master mold 102 has a shape in which the pattern region 401 is recessed from the surface to which the pattern peripheral region 120 belongs, so that a step is formed.

In the second embodiment, a replica blank 103 has a flat surface 410 having an area larger than the area of a replica pattern portion 403 at a bonding interface 130, and the replica pattern portion 403 is formed on the flat surface 410. However, as in the first embodiment, the replica blank 103 may have a mesa, and the replica pattern portion 403 may be formed on the mesa of the replica blank 103. In this case, the area of the top surface of the mesa of the replica blank 103 may be larger than the area of the pattern region 401 of the master mold 102.

FIG. 4A schematically shows the arranging step. In the arranging step, an application unit 115 can apply or arrange a plurality of droplets 201 of a curable composition 104 on the pattern region 401 of the master mold 102. Note that the arranging step may be executed by an apparatus outside the replica mold manufacturing apparatus 101, as described above. The application unit 115 is controlled based on control information stored in advance in the controller 117, and can arrange the droplets 201 of the curable composition 104 on the pattern region 401.

FIG. 4B schematically shows the filling step. In the filling step, the curable composition is filled into the space between the replica blank 103 and the pattern region 401 of the master mold 102. The filling step includes a contact step of bringing the droplets 201 of the curable composition arranged on the pattern region 401 of the master mold 102 and the replica region 402 of the replica blank 103 into contact with each other. When the droplets 201 of the curable composition arranged on the pattern region 401 are brought into contact with the replica region 402, the curable composition is started to be filled into the space between the pattern region 401 and the replica region 402. In the filling step, the curable composition can spread along the flat surface (replica region 402) of the replica blank 103. A mark for alignment with the master mold 102 may be arranged in the replica region 402. An adhesive material can be applied to the replica region 402.

FIG. 4C schematically shows the curing step. In the curing step, the replica pattern portion 403 with the pattern of the pattern region 401 transferred thereto is formed by curing the curable composition. When a curing unit 111 applies curing energy to the liquid film of the curable composition between the pattern region 401 and the replica region 402, the curable composition is cured and the replica pattern portion 403 is formed. Curing of the curable composition can be accompanied by a shrinkage of the volume of the curable composition. This shrinkage makes it easy to separate the pattern region 401 from the formed replica pattern portion 403.

FIG. 4D schematically shows the separating step. In the separating step, the replica pattern portion 403 and the master mold 102 are separated from each other. In the separating step, for example, a second driving mechanism 110 can drive the replica pattern portion 403 in a direction (+Z direction) away from the master mold 102. In the separating step, the controller 117 can separate the replica pattern portion 403 and the master mold 102 from each other by controlling the second driving mechanism 110 in accordance a driving profile set in advance. Here, in a state in which the replica blank 103 and the replica pattern portion 403 are connected to each other, the replica pattern portion 403 and the master mold 102 are separated from each other, and a replica mold 140 formed from the replica pattern portion 403 and the replica blank 103 is obtained. In the second embodiment, the area of the replica pattern portion 403 at the bonding interface 130 between the replica blank 103 and the replica pattern portion 403 is larger than the area of the pattern region 401. In addition, in an orthogonal projection to the bonding interface 130, the pattern region 401 fits in the region of the replica pattern portion 403 at the bonding interface 130. The bonding interface 130 between the replica blank 103 and the replica pattern portion 403 is the whole or a part of the replica region 402 of the replica blank 103. The replica mold 140 manufactured by the manufacturing method described above is used in an imprint process for manufacturing an article.

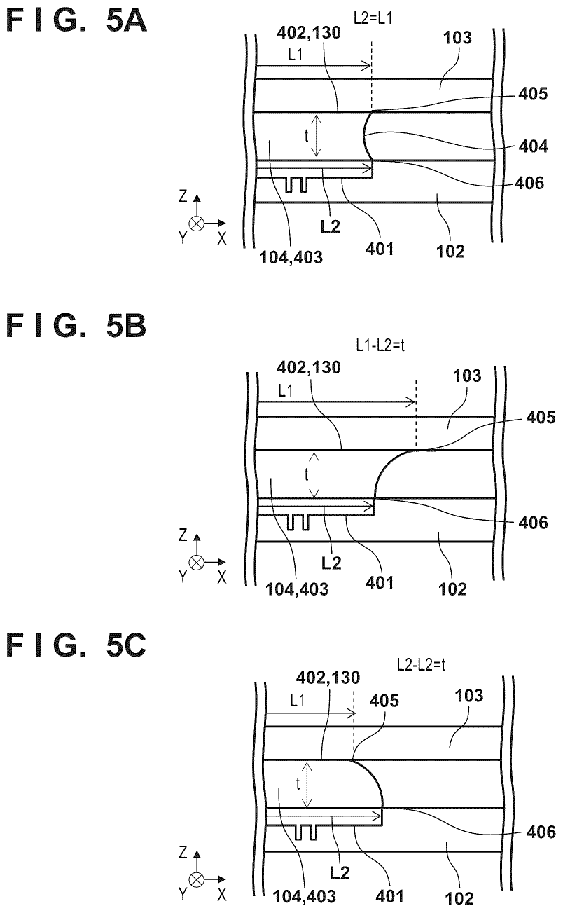

Each of FIGS. 5A to 5C schematically shows the sectional structure near the end portion of the pattern region 401 and the end portion of the replica region 402. With reference to FIGS. 5A to 5C, a preferable relationship between the area of the replica pattern portion 403 at the bonding interface 130 between the replica blank 103 and the replica pattern portion 403 and the area of the pattern region 401 of the master mold 102 will be described. Each of FIGS. 5A to 5C is a schematic view of an X-Z section passing through the center of the pattern region 401 and the center of the replica region 402.

Let L1 be ½ the dimension of the bonding interface 130 in a direction (for example, the X direction) parallel to the bonding interface 130 between the replica blank 103 and the replica pattern portion 403, L2 be ½ the dimension of the pattern region 401 in this direction, and t be the thickness of the replica pattern portion 403. L1 may be understood as the distance from the center of the bonding interface 130 to the outer edge of the bonding interface 130. L2 may be understood as the distance from the center of the pattern region 401 to the outer edge of the pattern region 401.

FIG. 5A schematically shows a case where the area of the replica region 402 (or the bonding interface 130) and the area of the pattern region 401 are equal to each other, in other words, a case where L1 and L2 are equal to each other. The outer peripheral portion of the curable composition 104 before being cured can form a meniscus (concave shape) 404. The shape of the meniscus 404 formed when the area of the replica region 402 (or the bonding interface 130) and the area of the pattern region 401 are equal to each other strongly depends on the control error of the thickness t of the replica pattern portion 403. This means that the controllability of the outer peripheral portion of the liquid film formed of the curable composition 104 is poor. In addition, if the shape of the meniscus 404 is unstable, when using the manufactured replica mold 140 in an imprint process, the pressure applied to a curable composition by the peripheral portion of the replica pattern portion 403 is unstable, and the imprint process can be unstable.

FIG. 5B schematically shows an example of a case where the area of the replica region 402 (or the bonding interface 130) is larger than the area of the pattern region 401, in which L1−L2=t is satisfied. If the area of the replica region 402 (or the bonding interface 130) is larger than the area of the pattern region 401, this is advantageous for obtaining a shape in which the sectional area at a plane parallel to the bonding interface 130 decreases as the distance from the bonding interface 130 increases. This means that the controllability of the outer peripheral portion of the liquid film formed of the curable composition 104 is good.

FIG. 5C schematically shows an example of a case where the area of the pattern region 401 is larger than the area of the replica region 402 (or the bonding interface 130), in which L2−L1=t is satisfied. If the area of the pattern region 401 is larger than the area of the replica region 402 (or the bonding interface 130), the area of the manufactured replica mold 140 that comes into contact with a curable composition in an imprint process becomes larger than the regular area. In this case, for example, other problems such as collision with an adjacent shot region can occur.

According to the study of the present inventors, the area of the replica pattern portion 403 at the bonding interface 130 between the replica blank 103 and the replica pattern portion 403 is preferably larger than the area of the pattern region 401 of the master mold 102. In another viewpoint, in order to stably obtain a shape in which the sectional area at a plane parallel to the bonding interface 130 decreases as the distance from the bonding interface 130 increases, the lower limit of (L1−L2) can be set to any one of 0.1t, 0.2t, 0.3t, 0.4t, 0.5t, 0.6t, 0.7t, 0.8t, and 0.9t. In order to prevent a thickness defect of the formed replica pattern portion 403, the upper limit of (L1−L2) can be set to any one of 2t, 1.9t, 1.8t, 1.7t, 1.6t, 1.5t, 1.4t, 1.3t, 1.2t, and 1.1t. In still another viewpoint, it is preferable that 0.1t≤L1−L2≤2t is satisfied, more preferably that 0.5t≤L1−L2≤1.5t is satisfied, and further preferably that 0.7t≤L1−L2≤1.3t is satisfied.

As the third embodiment, an article manufacturing method for manufacturing an article such as a semiconductor device or a MEMS will be described below. The article manufacturing method according to the third embodiment can include a step of manufacturing a replica mold in accordance with the above-described replica mold manufacturing method. The article manufacturing method can also include a step of forming, on a substrate, a pattern formed of the cured product of a curable composition by using the replica mold, and a step of obtaining an article by processing the substrate with the pattern formed thereon. The article manufacturing method may include a step of peeling off a replica pattern portion in accordance with the deterioration of the replica mold, and manufacturing (reproducing) the replica mold again. The step of processing the substrate with the pattern formed thereon can include, for example, steps of etching, resist removal, dicing, bonding, packaging, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-117964, filed Jul. 23, 2024 which is hereby incorporated by reference herein in its entirety.

What is claimed is:

1. A method of manufacturing a replica mold, the method comprising:
filling a curable composition into a space between a replica blank and a pattern region of a master mold;
curing the curable composition to form a replica pattern portion with a pattern of the pattern region transferred thereto; and
separating the replica pattern portion and the master mold from each other,
wherein
the master mold includes a pattern peripheral region surrounding the pattern region, and there is a step between the pattern region and the pattern peripheral region, and
an area of the replica pattern portion at a bonding interface between the replica blank and the replica pattern portion is larger than an area of the pattern region.

2. The method according to claim 1, wherein
in the filling, the replica blank is arranged on the master mold.

3. The method according to claim 2, wherein
the filling includes bringing the curable composition arranged on the pattern region of the master mold into contact with the replica blank.

4. The method according to claim 3, wherein
the master mold has a mesa, and the pattern region is arranged on the mesa.

5. The method according to claim 3, wherein
the replica blank has a mesa, and the replica pattern portion is formed on the mesa of the replica blank.

6. The method according to claim 5, wherein
an area of a top surface of the mesa of the replica blank is larger than an area of the pattern region.

7. The method according to claim 6, wherein
in the filling, the curable composition spreads along the top surface, and reaches an end portion of the top surface.

8. The method according to claim 3, wherein
the master mold has a concave portion, and the pattern region is arranged in the concave portion.

9. The method according to claim 8, wherein
the replica blank has a flat surface having an area larger than an area of the replica pattern portion at the bonding interface, and the replica pattern portion is formed on the flat surface.

10. The method according to claim 9, wherein
the replica blank has a mesa, and the replica pattern portion is formed on the mesa of the replica blank.

11. The method according to claim 10, wherein
an area of a top surface of the mesa of the replica blank is larger than an area of the pattern region.

12. The method according to claim 1, wherein
in the replica pattern portion, a sectional area at a plane parallel to the bonding interface decreases as a distance from the bonding interface increases.

13. The method according to claim 1, wherein
in an orthogonal projection to the bonding interface, the pattern region fits in a region of the replica pattern portion at the bonding interface.

14. The method according to claim 1, wherein
assuming that L1 is defined as ½ a dimension of the bonding interface in a direction parallel to the bonding interface, L2 is defined as ½ a dimension of the pattern region in the direction, and t is defined as a thickness of the replica pattern portion,
0.1t≤L1−L2≤2t
is satisfied.

15. The method according to claim 1, wherein
assuming that L1 is defined as ½ a dimension of the bonding interface in a direction parallel to the bonding interface, L2 is defined as ½ a dimension of the pattern region in the direction, and t is defined as a thickness of the replica pattern portion,
0.5t≤L1−L2≤1.5t
is satisfied.

16. The method according to claim 1, wherein
assuming that L1 is defined as ½ a dimension of the bonding interface in a direction parallel to the bonding interface, L2 is defined as ½ a dimension of the pattern region in the direction, and t is defined as a thickness of the replica pattern portion,
0.7t≤5L1-L2≤51.3t
is satisfied.

17. The method according to claim 1, wherein
a thickness of the replica pattern portion falls within a range of not less than 0.1 μm to not more than 1,000 μm.

18. An article manufacturing method comprising:
manufacturing a replica mold, including:
filling a curable composition into a space between a replica blank and a pattern region of a master mold;
curing the curable composition to form a replica pattern portion with a pattern of the pattern region transferred thereto; and
separating the replica pattern portion and the master mold from each other,
wherein the master mold includes a pattern peripheral region surrounding the pattern region, and there is a step between the pattern region and the pattern peripheral region, and an area of the replica pattern portion at a bonding interface between the replica blank and the replica pattern portion is larger than an area of the pattern region;
forming, on a substrate, a pattern formed of a cured product of a curable composition by using the replica mold; and
obtaining an article by processing the substrate with the pattern formed thereon.
